(19) United States
(12) Patent Application Publication
(10) Pub. No.: US 2017/0153722 A1
(43) Pub. Date: Jun. 1, 2017

(54) CAPACITIVE STYLUS AND OPERATION SYSTEM FOR THE SAME

(71) Applicant: EMRight Technology Co., Ltd., Hsinchu City (TW)

(72) Inventors: CHIA-TE HUANG, New Taipei City (TW); Yan-Chin Hsu, Hsinchu County (TW)

(21) Appl. No.: 15/171,107

(22) Filed: Jun. 2, 2016

(30) Foreign Application Priority Data
Nov. 27, 2015 (TW) 104219141

(51) Int. Cl. G06F 3/0354; G06F 3/038; G06F 1/32; G06F 3/044; G06F 3/041

(52) U.S. Cl. CPC G06F 3/03545; G06F 3/044; G06F 3/0416; G06F 3/0414; G06F 1/3262; G06F 3/0383

(57) ABSTRACT

A capacitive stylus applied to a capacitive touch panel as an input means includes a detection unit, a calculation unit and an output unit. The detection unit is to contact the capacitive touch panel. The calculation unit is electrically coupled with the detection unit. The output unit is electrically coupled with the calculation unit. When the detection unit contacts the capacitive touch panel, the detection unit generates a corresponding inductance-varying value, the calculation unit bases on the inductance-varying value to modulate and generate an oscillation frequency to the output unit, and the output unit bases on the oscillation frequency to output a frequency signal to the capacitive touch panel. Further, an operation system is provided to integrate the capacitive stylus and the capacitive touch panel.

This application claims the benefit of Taiwan Patent Application Serial No. 104219141, filed Nov. 27, 2015, the subject matter of which is incorporated herein by reference.

### BACKGROUND OF INVENTION

1. Field of the Invention

The invention relates to a stylus, and more particularly to a capacitive stylus and a corresponding operation system for the capacitive stylus that can be applied a touch panel.

2. Description of the Prior Art

Among all the consumer electronics in the market place, products with touch panels become popular. Particularly, in the art of touch panels, a capacitive touch panel is featured in utilizing human conductivity and static electricity. When user's finger touches directly a touch area of the touch panel, the capacitance at the contact point would be changed. Thus, the touch panel can judge the exact position of the contact point according to the change of the capacitance.

Though the aforesaid finger operation could be so straight forward and convenient, yet such an operation could not be so relevant to all situations. For example of hand writing, mass or swift input might be significantly retarded by the friction between the finger and the touch panel. Also, while in clicking an application, mis-selection might occur due to the not-so-small touch area produced by the finger.

To resolve the aforesaid shortcomings, a stylus is developed. Currently, the stylus can be passive or active. The passive capacitive stylus applies a conductive pen tip as a medium between the touch panel and the user. When a user manipulates the capacitive stylus to touch the touch panel, the capacitance at the touch point of stylus's pen tip would vary, and thereby the exact coordinate of the touch point on the touch panel can be precisely located by judging the change of capacitance over the touch panel. However, the judgment of the touch point could still be weak if the touch area provided by the passive stylus upon the touch screen is too small. Such a limitation for the pen tip of the stylus would influence the design of the stylus, especially at the pen tip. If the touch area provided by the pen tip on the touch screen is too small, then the judgment thereof might be weak. However, if the touch area provided by the pen tip on the touch screen is too big, then a precise pin-point judgment at the contact point might be difficult. On the other hand, the active capacitive stylus includes at least a power-managing unit, a control unit, a contact-detecting element and a signal-generating circuit. When the active capacitive stylus touch the touch panel, the contact-detecting element would be activated, and the control unit would realize the data provided by the contact-detecting element so as to obtain information regarding the instant touching of the pen tip of the active capacitive stylus on the touch careen. To precisely calculate the touching, a precision control unit is definitely required. However, such a control unit in the art is usually expensive and has a non-negligible size. To implement the precision control unit into the active capacitive stylus, complicate structuring, bigger sizing and higher pricing would be inevitable.

### SUMMARY OF THE INVENTION

Accordingly, it is the primary object of the present invention to provide a capacitive stylus. When the capacitive stylus is depressed, a calculation unit would base on a corresponding inductance-varying value to modulate and generate an oscillation frequency to an output unit. The output unit then bases on the oscillation frequency to output a frequency signal to a capacitive touch panel, so that the capacitive touch panel can calculate a pen-tip voltage of the capacitive stylus.

In the present invention, an operation system for a capacitive stylus is provided. When the capacitive stylus is depressed, the capacitive stylus modulates and generates a signal, and a capacitive touch panel receives the signal generated by the capacitive stylus and calculates a pen-tip voltage of the capacitive stylus.

In the present invention, a capacitive stylus applied to a capacitive touch panel as an input means includes a detection unit, a calculation unit and an output unit. The detection unit is to contact the capacitive touch panel. The calculation unit is electrically coupled with the detection unit. The output unit is electrically coupled with the calculation unit. When the detection unit contacts the capacitive touch panel, the detection unit generates a corresponding inductance-varying value, the calculation unit bases on the inductance-varying value to modulate and generate an oscillation frequency to the output unit, and the output unit bases on the oscillation frequency to output a frequency signal to the capacitive touch panel.

In the present invention, a capacitive stylus applied to a capacitive touch panel as an input means includes a detection unit and a calculation unit. The detection unit is to contact the capacitive touch panel. The calculation unit is electrically coupled with the detection unit. When the detection unit contacts the capacitive touch panel, the detection unit generates a corresponding inductance-varying value, and the calculation unit bases on the inductance-varying value to modulate and generate an oscillation frequency to the capacitive touch panel.

In the present invention, an operation system for a capacitive stylus includes a capacitive stylus and a capacitive touch panel. When the capacitive stylus contacts the capacitive touch panel, the capacitive stylus modulates and generates a signal, and the capacitive touch panel receives the signal generated by the capacitive stylus and calculates a pen-tip voltage of the capacitive stylus.

By providing the capacitive stylus and the operation system for the capacitive stylus in accordance with the present invention, when the capacitive stylus is depressed, the calculation unit would base on the inductance-varying value to modulate and generate an oscillation frequency to the output unit, and the output unit bases on the oscillation frequency to output a frequency signal to the capacitive touch panel so as to have the capacitive touch panel to calculate a pen-tip voltage of the capacitive stylus. Thus, the capacitive stylus of the present invention does not need the control unit, such as the MCU or the microprocessor of the conventional capacitive stylus, to calculate the voltage value of the depressed capacitive stylus. Contrarily, the calculation unit of the present invention can directly output the corresponding oscillation frequency to the capacitive touch panel. Upon such an arrangement, the overall volume of the capacitive stylus can be smaller, the production cost for the capacitive stylus can be reduced, and the usage convenience of the capacitive stylus can be enhanced.

All these objects are achieved by the capacitive stylus and the operation system for the same described below.

### BRIEF DESCRIPTION OF THE DRAWINGS

The present invention will now be specified with reference to its preferred embodiment illustrated in the drawings, in which:

FIG. 1 is a schematic view of an embodiment of the capacitive stylus in accordance with the present invention;

FIG. 2 is a functional block view of the embodiment of

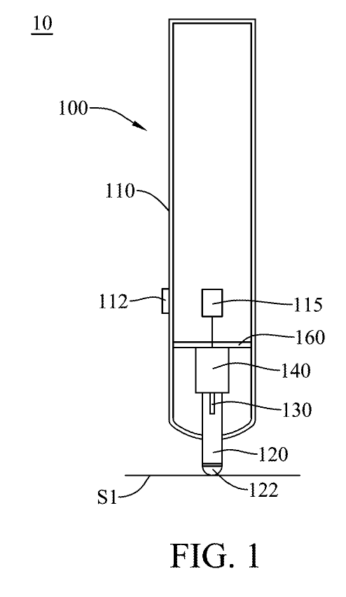

FIG. 1,

FIG. 3 shows two types of voltage waveforms for the capacitive stylus in accordance with the present invention;

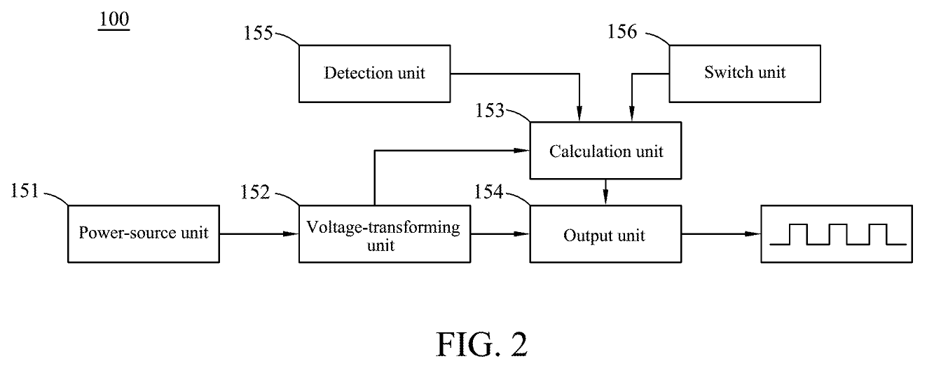

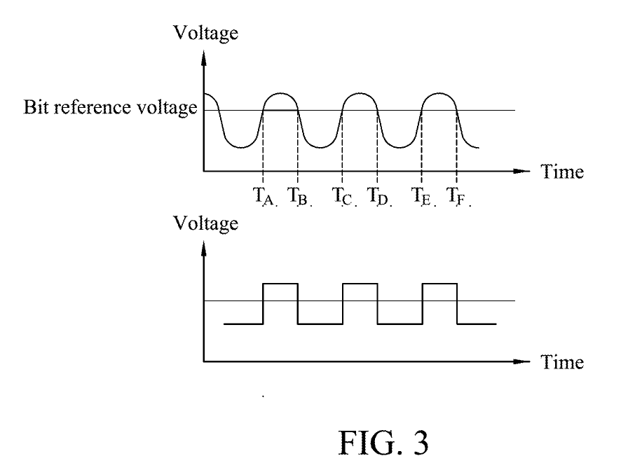

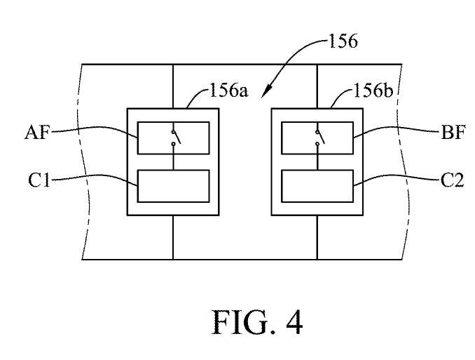

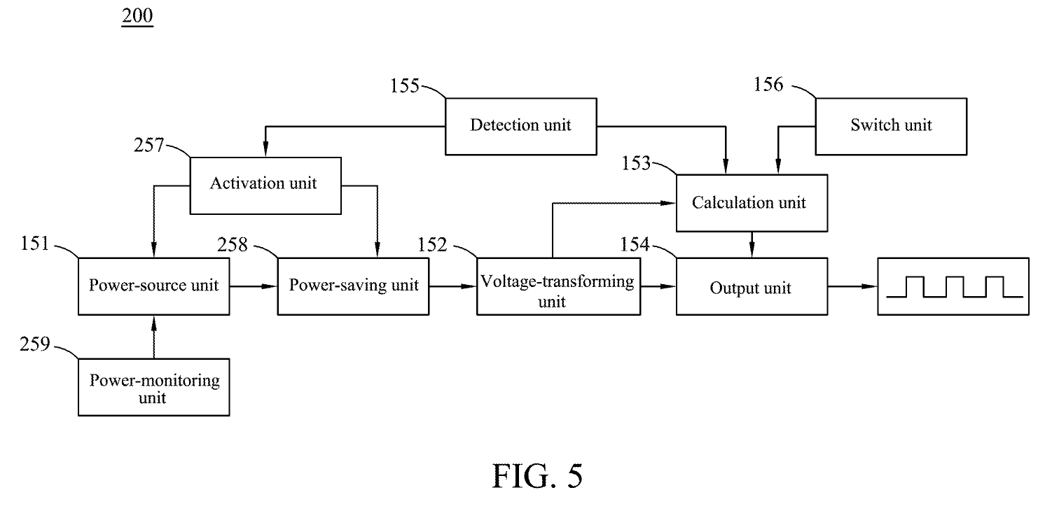

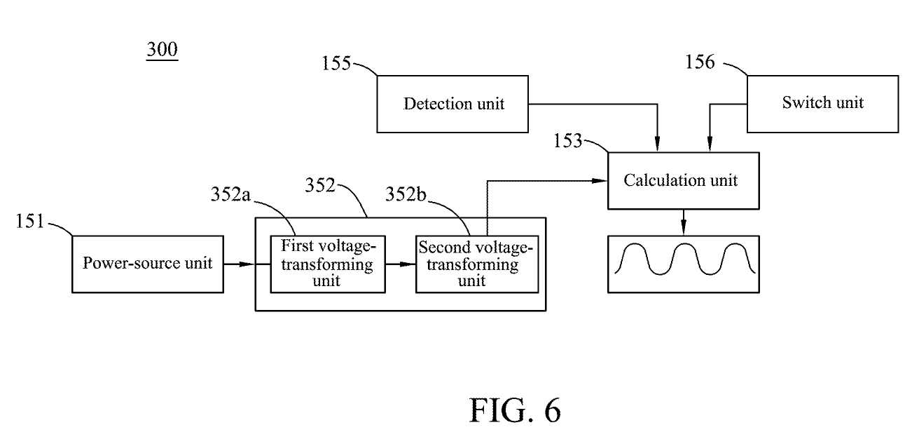

FIG. 4 is a schematic view of the switch unit of FIG. 2;

FIG. 5 is a functional block view of another embodiment of the capacitive stylus in accordance with the present invention; and

FIG. 6 is a functional block view of a further embodiment of the capacitive stylus in accordance with the present invention.

### DESCRIPTION OF THE PREFERRED EMBODIMENT

The invention disclosed herein is directed to a capacitive stylus and an operation system for the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Referring now to FIG. 1, a schematic view of an embodiment of the capacitive stylus in accordance with the present invention is shown.

In this embodiment, the operation system 10 for a capacitive stylus includes the capacitive stylus 100 and a capacitive touch panel S1, in which the capacitive stylus 100 is applied to the capacitive touch panel S1 as an input means.

The capacitive stylus 100 includes a housing 110, a penetration portion 120, a magnetic structure 130, an induction-coil portion 140, a positioning unit 160, a push-button unit 112 and an oscillation unit 115.

The housing 110 made of a plastics or a metal can be shaped as a hollow square cylinder. The push-button unit 112 is located at an exterior of the housing 110. The housing 110 formed as the hollow square cylinder has an interior accommodation space for nesting thereinside the magnetic structure 130, the induction-coil portion 140, the positioning unit 160, the oscillation unit 115 and a part of the penetration portion 120. In this embodiment, the appearance of the capacitive stylus 100 is not limited to the shape shown in the figure herein. In some other embodiments not shown here, the appearance of the capacitive stylus 100 can be a hollow circular or polygon cylinder.

The penetration portion 120 located to one end of the housing 110 includes a contact portion 122 protrusive out of the housing 110. The contact portion 122 made of a conductive material is to contact the capacitive touch panel S1 so as thereby to produce a change of the capacitance on the capacitive touch panel S1.

The induction-coil portion 140 is located inside the housing 110, and the penetration portion 120 is movably located at the induction-coil portion 140.

The magnetic structure 130 is located inside the penetration portion 120 and connects with the induction-coil portion 140. In detail, the magnetic structure 130 contains thereinside an iron dust core, a ferro magnetic material, an oxidation magnet or the like magnetic ferrite material.

The oscillation unit 115 located inside the housing 110 is electrically coupled with the induction-coil portion 140 (including the induction coil) so as to form an oscillation circuit.

Upon the aforesaid arrangement, when the contact portion 122 of the capacitive stylus 100 is free of contact, the penetration portion 120 and the magnetic structure 130 would be disposed at an initial position. When the contact portion 122 of the capacitive stylus 100 contacts the capacitive touch panel S1, the contact portion 122 is depressed and then displaces simultaneously the penetration portion 120 and the magnetic structure 130, such that the penetration portion 120, the magnetic structure 130 and the induction-coil portion 140 would be moved by the same displacement in an axial direction. Thereby, the induction-coil portion 140 would generate an inductance-varying value, and the oscillation unit 115 would base on the inductance-varying value to generate an oscillation frequency. Namely, the capacitive stylus 100 is modulated to generate a signal (such as the oscillation frequency). In this embodiment, the signal is an analog signal, not a digital signal or an enveloped signal calculated by the control unit inside the capacitive stylus 100. After the capacitive touch panel S1 receives the signal generated by the capacitive stylus 100, a corresponding pen-tip voltage of the capacitive stylus 100 is then calculated.

Obviously, by providing the present invention, the capacitive stylus 100 does not need the MCU of the conventional capacitive stylus or the control unit of the microprocessor to calculate the voltage value generated from depressing the capacitive stylus 100, such that the overall volume of the capacitive stylus 100 can be smaller, the production cost for the capacitive stylus 100 can be reduced, and the usage convenience of the capacitive stylus 100 can be enhanced.

Detail descriptions upon circuiting, functions and operations for the capacitive stylus 100 would be elucidated as follows. Refer now to FIG. 1 and FIG. 2, where FIG. 2 is a functional block view of the embodiment of FIG. 1.

In this embodiment, the capacitive stylus 100 is applied to a capacitive touch panel S1 as one of input means. The capacitive stylus 100 includes a power-source unit 151, a voltage-transforming unit 152, a calculation unit 153, an output unit 154, a detection unit 155 and a switch unit 156.

The power-source unit 151 electrically coupled with the voltage-transforming unit 152 is to provide an electric power to the voltage-transforming unit 152. The power-source unit 151 can be, but not limited to, a battery, a secondary battery, a rechargeable battery, or any element that is able to provide electric power.

The voltage-transforming unit 152 electrically coupled with the calculation unit 153 is to transform and generate a first voltage and a second voltage. The calculation unit 153 then receives the first voltage generated by the voltage-transforming unit 152, and the output unit 154 receives the second voltage generated by the voltage-transforming unit 152. In this embodiment, the first voltage is not equal to the second voltage.

In this embodiment, the voltage-transforming unit 152 can utilize a voltage-transforming circuit, a voltage-boosting circuit or a second voltage-boosting circuit to serve its function. For example, the voltage-boosting circuit can transform the battery voltage from the power-source unit 151 into a corresponding voltage applicable to the calculation unit 153 or the output unit 154. Nevertheless, the embodiment of the voltage-transforming unit in accordance with the present invention is not limited to any described above, and a relevant embodiment is dependent to practical requirements. In some other embodiments, the voltage-transforming unit 152 can include a transformation chip such as, but not limited to, a CMOS step-up switching regulator controller.

The calculation unit 153 electrically coupled with the detection unit 155 can be an oscillation circuit or a Colpitts circuit. By having the Colpitts circuit as an example, the oscillation frequency is determined by two capacitors and an inductor. In this embodiment, the calculation unit 153 oscillates the first voltage forwarded from the voltage-transforming unit 152 to generate a corresponding oscillation frequency.

In this embodiment, the detection unit 155 for contacting the capacitive touch panel S1 can be, but not limited to, a pressure-detecting element further including at least the contact portion 122 of the penetration portion 120, the magnetic structure 130 and springs (not shown in the figure).

The output unit 154 is electrically coupled with the calculation unit 153.

Upon the aforesaid arrangement, when the detection unit 155 contacts the capacitive touch panel S1, the detection unit 155 would generate a corresponding inductance-varying value, and then the calculation unit 153 would base on the inductance-varying value to modulate and generate a corresponding oscillation frequency to the output unit 154. The output unit 154 bases on the oscillation frequency to output a frequency signal to the capacitive touch panel S1. In the present invention, the oscillation frequency is a sinusoidal frequency, and the frequency signal is a square-wave signal.

Namely, the calculation unit 153 would base on the inductance-varying value to modulate and thus generate the oscillation frequency. By having the Colpitts circuit as an example, the oscillation frequency can be expressed as the following mathematic expression (1).

$${f}_{c} ≅ \frac{1}{2 π \sqrt{LC}} \qquad ( 1 )$$

In the aforesaid mathematic expression (1), the fc stands for the oscillation frequency of the Colpitts circuit, the L stands for the inductance of the Colpitts circuit (namely, the inductance-varying value generated according to the displacement between the magnetic structure 130 and the induction-coil portion 140 as shown in FIG. 1), and the C stands for the capacitance of the Colpitts circuit (namely, the capacitance of the oscillation unit 115 as shown in FIG. 1).

In addition, the switch unit 156 is electrically coupled with the calculation unit 153. In this embodiment, when the switch unit 156 is free of any depression, the capacitance C in the aforesaid mathematic expression (1) is a constant. Hence, as the inductance L varies, the oscillation frequency fc would change as well. Accordingly, a displacement between the magnetic structure 130 and the induction-coil portion 140 would induce the induction-coil portion 140 to generate an inductance-varying value.

For example, if a larger depression is applied to the contact portion 122 of the penetration portion 120, the displacement between the magnetic structure 130 and the induction-coil portion 140 would be larger, and the corresponding oscillation frequency would be lower. Contrarily, if a smaller depression is applied to the contact portion 122 of the penetration portion 120, the displacement between the magnetic structure 130 and the induction-coil portion 140 would be smaller, and the corresponding oscillation frequency would be higher. Hence, with a constant capacitance C, the calculation unit 153 can base on the scale of the depression upon the contact portion 122 of the penetration portion 120 to modulate and thus generate a corresponding oscillation frequency.

Namely, the inductance in the calculation unit 153 would affect the value of the oscillation frequency.

Practically, the output unit 154 of the present invention can be a transistor-switching circuit that issues a frequency signal to the capacitive touch panel S1 while being applied by a specific high voltage. However, the embodiment of the output unit 154 in the present invention can be various, and is not limited to the aforesaid transistor-switching circuit. For example, in another embodiment, the transistor-switching circuit can include two MOSFETs.

For example, the gate of the MOSFET can be electrically coupled with the calculation unit 153, such that the MOSFET can be controlled by the voltage fluctuation amplitude of the oscillation frequency. Thus, when the bit reference voltage of the voltage fluctuation amplitude is raised to a preset bit reference voltage, the transistor-switching circuit (i.e. the output unit 154) can be energized and then closed. On the other hand, when the bit reference voltage of the voltage fluctuation amplitude is lowered to a preset bit reference voltage, the transistor-switching circuit (i.e. the output unit 154) would be opened, such that the output unit 154 would generate a corresponding frequency signal.

Referring to FIG. 3, two types of voltage waveforms for the capacitive stylus in accordance with the present invention are shown. In FIG. 3, the horizontal axis stands for the time, while the vertical axis stands for the voltage.

Refer to the upper portion of FIG. 3, it shows that the voltage wave shape is a sinusoidal wave. At time point T_{A} when the waving of the voltage fluctuation amplitude for this oscillation frequency is raised to a predetermined bit reference voltage, the transistor-switching circuit (i.e. the output unit 154) is energized and thus closed, and the corresponding frequency signal is transformed from a low logic level to a high logic level. It shall be noted that the predetermined bit reference voltage is a reference voltage level that can adjust the circuit to be opened or closed according to the waving of the voltage fluctuation amplitude for this oscillation frequency.

At time point T_{B} when the waving of the voltage fluctuation amplitude for this oscillation frequency is lowered to the predetermined bit reference voltage, the transistor-switching circuit is opened, and the corresponding frequency signal is transformed from a high logic level to a low logic level.

Similarly, at time point T_{C} when the waving of the voltage fluctuation amplitude for this oscillation frequency is raised to the predetermined bit reference voltage, the transistor-switching circuit is energized and closed, and the corresponding frequency signal is transformed from a low logic level to a high logic level again. At time point T_{D} when the waving of the voltage fluctuation amplitude for this oscillation frequency is lowered again to the predetermined bit reference voltage, the transistor-switching circuit is thus opened, and the corresponding frequency signal is transformed from a high logic level to a low logic level. In the following two time points T_{E} and T_{F}, the aforesaid trend in the waving of the voltage fluctuation amplitude for this oscillation frequency is repeated. Hence, the voltage wave for this sinusoidal frequency shown in the upper portion of FIG. 3 would induce a corresponding change in the square-wave signals shown in the lower portion of FIG. 3.

Accordingly, in this embodiment, the waving of the voltage fluctuation amplitude for this specific oscillation frequency is applied to switch close/open states for the output unit 154 by formulating a square-wave signal outputted by the output unit 154, as shown in FIG. 2, and forwarded to the capacitive touch panel S1. The frequency of the square-wave signal is the same as that of the oscillation frequency.

In this embodiment, when the switch unit 156 is depressed, the switch unit 156 would evaluate the scale of the depression, and thereby modulate and generate an oscillation frequency of the push-button action to the output unit 154. The aforesaid oscillation frequency of the push-button action would be transformed into a corresponding frequency signal by the output unit 154 so as further to be transmitted to the capacitive touch panel S1.

Refer now to FIG. 2 and FIG. 4, in which FIG. 4 is a schematic view of the switch unit of FIG. 2.

In this embodiment, the switch unit 156 includes a first switch element 156a and a second switch element 156b. The first switch element 156a is connected in parallel with the second switch element 156b, and the first switch element 156a and the second switch element 156b are individually electrically coupled with the calculation unit 153. In this embodiment, the calculation unit 153 is a Colpitts circuit. When the first switch element 156a is depressed, the oscillation frequency of the push-button action is within a first frequency domain. When the second switch element 156b is depressed, the oscillation frequency of the push-button action is within a second frequency domain.

The first switch element 156a includes at least one capacitor. When the first switch element 156a is depressed, the at least one capacitor is then closed. The capacitor that is closed to the Colpitts circuit would generate a larger capacitance so as to modulate the oscillation frequency of the push-button action down to be within a first frequency domain. Namely, when the first switch element 156a is depressed, the capacitance in the calculation unit 153 would become larger so as to modulate the oscillation frequency of the push-button action down to be within the first frequency domain. Similarly, the second switch element 156b includes at least one capacitor. When the second switch element 156b is depressed, then the at least one capacitor is closed. The capacitor of the at least one closed capacitor and the Colpitts circuit would generate a larger capacitance so as to modulate the oscillation frequency of the push-button action down to be within a second frequency domain. Namely, when the second switch element 156b is depressed, the capacitance in the calculation unit 153 would become larger so as to modulate the oscillation frequency of the push-button action down to be within the second frequency domain. In the present invention, the first frequency domain is different to the second frequency domain.

Practically, the first switch element 156a can include a first push button AF and a plurality of first capacitors C1, in which the first push button AF connects in series with the plurality of the first capacitors C1. The second switch element 156b can include a second push button BF and a plurality of second capacitors C2, in which the second push button BF connect in series with the plurality of second capacitors C2.

It shall be noted that the Colpitts circuit of this embodiment can be a circuit having NPN transistors Q3 integrated by common-base amplifiers. In some other embodiments, the Colpitts circuit can be a circuit having NPN transistors Q3 integrated by common-collector amplifiers. Namely, the embodiment of the Colpitts circuit in the present invention cab be various, not necessarily limited to the aforesaid formulations.

By having this embodiment as a typical example, the Colpitts circuit includes a plurality of capacitors connected in parallel. When the first switch element 156a or the second switch element 156b is free of depression, the capacitance corresponding to the Colpitts circuit is a constant. Then, when the capacitive stylus touches the capacitive touch panel, the capacitive stylus can base on the change in inductance and the constant capacitance to modulate and output a frequency signal to the capacitive touch panel, such that the capacitive touch panel can calculate the pen-tip voltage of the capacitive stylus.

When the first switch element 156a is depressed, the first capacitor C1 connects in parallel with the plurality of capacitors of the calculation unit 153 (i.e. the Colpitts circuit) so as to vary the capacitance. Since the inductance herein is a constant, thus, according to the aforesaid mathematic expression (1), the frequency of the push-button action can be modulated to be within 131˜134 kHz. Similarly, when the second switch element 156b is depressed, the second capacitor C2 connects in parallel with the plurality of capacitors of the calculation unit 153 (i.e. the Colpitts circuit)) so as to vary the capacitance. Since the inductance herein is a constant, thus, according to the aforesaid mathematic expression (1), the frequency of the push-button action can be modulated to be within 136˜139 kHz.

Referring to FIG. 5, a functional block view of another embodiment of the capacitive stylus in accordance with the present invention is shown. It is noted that, in the embodiment of FIG. 5, the capacitive stylus 200 herein is similar to the capacitive stylus 100 of FIG. 2, and some identical elements with the same numbers are applied in both the embodiments. In the following description, only the elements of FIG. 5 not shown in FIG. 2 would be elucidated.

In this embodiment, the capacitive stylus 200 further includes an activation unit 257, a power-saving unit 258 and a power-monitoring unit 259.

One end of the activation unit 257 connects the power-saving unit 258, while another end thereof connects the power-source unit 151. The power-saving unit 258 electrically couples the voltage-transforming unit 152 and the power-source unit 151.

The power-monitoring unit 259 electrically coupled with the power-source unit 151 is to monitor the power-source unit 151.

For example, if the power-monitoring unit 259 detects that the voltage of the power-source unit 151 is smaller than a preset voltage, then the power-monitoring unit 259 would light up an indicator so as to alert relevant users to replace the power-source unit 151.

Under such an arrangement, when the detection unit 155 is depressed, the power-saving unit 258 is used to drive the voltage-transforming unit 152. On the other hand, when the detection unit 155 is free of contact for a waiting time, the power-saving unit 258 would put the voltage-transforming unit 152 into a waiting mode.

Practically, the activation unit 257 can be closed by the depressed detection unit 155. In this embodiment, the activation unit 257 would be energized and then closed according to the relative displacement between the magnetic structure 130 and the induction-coil portion 140.

When the activation unit 257 is closed, a capacitor in the power-saving unit 258 would be charged so as to reach a charged bit reference voltage. Such a charged bit reference voltage would put the voltage-transforming unit 152 (a transformer chip for example) into a close state. Thus, a corresponding frequency signal would be generated after operating the voltage-transforming unit 152, the calculation unit 153 and the output unit 154.

On the other hand, if the capacitive stylus 200 is away, then the electricity of the capacitor in the power-saving unit 258 would be released to a ground end through a resistor. After a period of waiting time, the electricity of the capacitor in the power-saving unit 258 would drop to a low level or even zero. Then, the power-saving unit 258 would have the voltage-transforming unit 152 to enter a waiting mode, such that the capacitive stylus 200 can be in a sleep or idle state.

Refer now to FIG. 1 and FIG. 6, where FIG. 6 is a functional block view of a further embodiment of the capacitive stylus in accordance with the present invention. It is noted that, in the embodiment of FIG. 6, the capacitive stylus 300 herein is similar to the capacitive stylus 100 of FIG. 2, and some identical elements with the same numbers are applied in both the embodiments. In the following description, only the elements of FIG. 6 not shown in FIG. 2 would be elucidated.

The major difference between the capacitive stylus 300 of FIG. 6 and the capacitive stylus 100 of FIG. 2 is that the voltage-transforming unit 352 of the capacitive stylus 300 includes a first voltage-transforming unit 352a and a second voltage-transforming unit 352b. Namely, the capacitive stylus 300 of this embodiment has two voltage-transforming units, and excludes the output unit 154 of FIG. 2.

Practically, the first voltage-transforming unit 352a is electrically coupled with the power-source unit 151, and the calculation unit 153 is electrically coupled with the second voltage-transforming unit 352b. The first voltage-transforming unit 352a is to transform and generate a first voltage. The second voltage-transforming unit 352b receives the first voltage generated by the first voltage-transforming unit 352a, and then bases on the first voltage to transform and generate a second voltage. The calculation unit 153 receives the second voltage generated by the second voltage-transforming unit 352b. Particularly, the first voltage is unequal to the second voltage.

The detection unit 155 is to contact the capacitive touch panel S1. In this embodiment, when the detection unit 155 contacts the capacitive touch panel S1, the detection unit 155 would generate a corresponding inductance-varying value. The calculation unit 153 would base on the inductance-varying value to modulate and generate a corresponding oscillation frequency to the capacitive touch panel S1, in which the oscillation frequency can be a sinusoidal frequency. Hence, the capacitive touch panel S1 can calculate the pen-tip voltage of the capacitive stylus 300.

For example, the first voltage-transforming unit 352a can transform a 0.9V battery voltage into a 5V first voltage. The second voltage-transforming unit 352b can transform a 5V first voltage into a 12V second voltage. Then, the calculation unit 153 would base on the 12V second voltage to output an oscillation frequency. When the detection unit 155 is depressed, a relative displacement between the magnetic structure 130 and the induction-coil portion 140 would be generated. Then, the calculation unit 153 can evaluate the change of the inductance generated by the depressed detection unit 155 to further modulate and output an oscillation frequency to the capacitive touch panel S1.

In addition, the switch unit 156 of the capacitive stylus 300 can adopt the first switch element 156a and the second switch element 156b of FIG.4. However, details thereabout can be referred to the foregoing descriptions around FIG. 4, and thus would be omitted herein.

In summary, in the capacitive stylus and the capacitive touch-control system in accordance with the present invention, when the capacitive stylus is depressed, the calculation unit would base on the inductance-varying value to modulate and generate an oscillation frequency to the output unit. The output unit would then base on the oscillation frequency to output a frequency signal to the capacitive touch panel, such that the capacitive touch panel can calculate the pen-tip voltage of the capacitive stylus. Hence, the capacitive stylus of the present invention does not need the control unit, such as the MCU or the microprocessor of the conventional capacitive stylus, to calculate the voltage value of the depressed capacitive stylus. Contrarily, in the present invention, the calculation unit directly outputs the corresponding oscillation frequency to the capacitive touch panel. Thus, the overall volume of the capacitive stylus can be smaller, the production cost for the capacitive stylus can be reduced, and the usage convenience of the capacitive stylus can be enhanced.

While the present invention has been particularly shown and described with reference to a preferred embodiment, it will be understood by those skilled in the art that various changes in form and detail may be without departing from the spirit and scope of the present invention.

What is claimed is:

1. A capacitive stylus, applied to a capacitive touch panel, comprising:
a detection unit for contacting the capacitive touch panel;
a calculation unit, electrically coupled with the detection unit; and
an output unit, electrically coupled with the calculation unit;
wherein, when the detection unit contacts the capacitive touch panel, the detection unit generates a corresponding inductance-varying value, the calculation unit bases on the inductance-varying value to modulate and generate an oscillation frequency to the output unit, and the output unit bases on the oscillation frequency to output a frequency signal to the capacitive touch panel.

2. The capacitive stylus of claim 1, wherein the oscillation frequency is a sinusoidal frequency, and the frequency signal is a square-wave signal.

3. The capacitive stylus of claim 1, further including:
a voltage-transforming unit, electrically coupled with the calculation unit; and
a power-source unit, electrically coupled with the voltage-transforming unit,
wherein the power-source unit is to provide electric power to the voltage-transforming unit, the voltage-transforming unit is to transform and generate a first voltage and a second voltage, the calculation unit is to receive the first voltage generated by the voltage-transforming unit, and the output unit is to receive the second voltage generated by the voltage-transforming unit.

4. The capacitive stylus of claim 3, further including:
a power-saving unit, electrically coupled with the voltage-transforming unit and the power-source unit; and
a power-monitoring unit, electrically coupled with the power-source unit, being to monitor electricity of the power-source unit;
wherein, when the detection unit is contacted, the power-saving unit is used to drive the voltage-transforming unit;
wherein, when the detection unit is free of contact for a waiting time, the power-saving unit is used to put the voltage-transforming unit into a waiting mode.

5. The capacitive stylus of claim 1, further including:
a switch unit, electrically coupled with the calculation unit, the calculation unit being a Colpitts circuit;
wherein, when the switch unit is depressed, the switch unit bases on depression upon the switch unit to modulate and generate a corresponding oscillation frequency to the output unit.

6. The capacitive stylus of claim 5, wherein the switch unit includes a first switch element and a second switch element, the first switch element and the second switch element being individually electrically coupled with the Colpitts circuit;
wherein, when the first switch element is depressed, the oscillation frequency is within a first frequency domain;
wherein, when the second switch element is depressed, the oscillation frequency is within a second frequency domain.

7. A capacitive stylus, applied to a capacitive touch panel, comprising:
a detection unit for contacting the capacitive touch panel; and
a calculation unit, electrically coupled with the detection unit;
wherein, when the detection unit contacts the capacitive touch panel, the detection unit generates a corresponding inductance-varying value, the calculation unit bases on the inductance-varying value to modulate and generate an oscillation frequency to the capacitive touch panel.

8. The capacitive stylus of claim 7, wherein the oscillation frequency is a sinusoidal frequency.

9. The capacitive stylus of claim 7, further including:
a power-source unit;
a first voltage-transforming unit, electrically coupled with the power-source unit; and
a second voltage-transforming unit, electrically coupled with the calculation unit;
wherein the power-source unit is to provide electric power to the first voltage-transforming unit, the first voltage-transforming unit is to transform and generate a first voltage, the second voltage-transforming unit receives the first voltage generated by the first voltage-transforming unit and bases on the first voltage to transform and generate a second voltage, and the calculation unit receives the second voltage generated by the second voltage-transforming unit.

10. The capacitive stylus of claim 8, further including:
a switch unit, electrically coupled with the calculation unit, the calculation unit being a Colpitts circuit;
wherein, when the switch unit is depressed, the switch unit bases on depression upon the switch unit to modulate and generate a corresponding oscillation frequency to an output unit electrically coupled with the calculation unit.

11. The capacitive stylus of claim 10, wherein the switch unit includes a first switch element and a second switch element, the first switch element and the second switch element being individually electrically coupled with the Colpitts circuit;
wherein, when the first switch element is depressed, the oscillation frequency is within a first frequency domain;
wherein, when the second switch element is depressed, the oscillation frequency is within a second frequency domain.

12. An operation system for a capacitive stylus, comprising:
a capacitive stylus, including a detection unit for contacting a capacitive touch panel, a calculation unit electrically coupled with the detection unit, and an output unit electrically coupled with the calculation unit; and
the capacitive touch panel;
wherein, when the detection unit of the capacitive stylus contacts the capacitive touch panel, the detection unit generates a corresponding inductance-varying value, the calculation unit bases on the inductance-varying value to modulate and generate an oscillation frequency to the output unit, the output unit bases on the oscillation frequency to output a frequency signal to the capacitive touch panel, and the capacitive touch panel receives the frequency signal generated by the capacitive stylus and calculates a pen-tip voltage of the capacitive stylus.

13. The operation system for a capacitive stylus of claim 12, wherein the oscillation frequency is a sinusoidal frequency, and the frequency signal is a square-wave signal.

14. The operation system for a capacitive stylus of claim 12, further including:
a voltage-transforming unit, electrically coupled with the calculation unit;
a power-source unit, electrically coupled with the voltage-transforming unit, being to provide electric power to the voltage-transforming unit, the voltage-transforming unit being to transform and generate a first voltage and a second voltage, the calculation unit being to receive the first voltage generated by the voltage-transforming unit, the output unit being to receive the second voltage generated by the voltage-transforming unit;
a power-saving unit, electrically coupled with the voltage-transforming unit and the power-source unit; and
a power-monitoring unit, electrically coupled with the power-source unit, being to monitor electricity of the power-source unit;
wherein, when the detection unit is contacted, the power-saving unit is used to drive the voltage-transforming unit;
wherein, when the detection unit is free of contact for a waiting time, the power-saving unit is used to put the voltage-transforming unit into a waiting mode.

15. The operation system for a capacitive stylus of claim 12, further including:
a switch unit, electrically coupled with the calculation unit, the calculation unit being a Colpitts circuit;
wherein, when the switch unit is depressed, the switch unit bases on depression upon the switch unit to modulate and generate a corresponding oscillation frequency to the output unit;
wherein the switch unit includes a first switch element and a second switch element, the first switch element and the second switch element being individually electrically coupled with the Colpitts circuit;
wherein, when the first switch element is depressed, the oscillation frequency is within a first frequency domain; and
wherein, when the second switch element is depressed, the oscillation frequency is within a second frequency domain.

16. An operation system for a capacitive stylus, comprising:
a capacitive stylus, including a detection unit for contacting a capacitive touch panel and a calculation unit electrically coupled with the detection unit; and
the capacitive touch panel;
wherein, when the detection unit of the capacitive stylus contacts the capacitive touch panel, the detection unit generates a corresponding inductance-varying value, the calculation unit bases on the inductance-varying value to modulate and generate an oscillation frequency to the capacitive touch panel, and the capacitive touch panel receives the oscillation frequency generated by the capacitive stylus and calculates a pen-tip voltage of the capacitive stylus.

17. The operation system for a capacitive stylus of claim 16, wherein the oscillation frequency is a sinusoidal frequency.

18. The operation system for a capacitive stylus of claim 16, further including:
a power-source unit;
a first voltage-transforming unit, electrically coupled with the power-source unit; and
a second voltage-transforming unit, electrically coupled with the calculation unit;
wherein the power-source unit is to provide electric power to the first voltage-transforming unit, the first voltage-transforming unit is to transform and generate a first voltage, the second voltage-transforming unit receives the first voltage generated by the first voltage-transforming unit and bases on the first voltage to transform and generate a second voltage, and the calculation unit receives the second voltage generated by the second voltage-transforming unit.

19. The operation system for a capacitive stylus of claim 16, further including:
a switch unit, electrically coupled with the calculation unit, the calculation unit being a Colpitts circuit;
wherein, when the switch unit is depressed, the switch unit bases on depression upon the switch unit to modulate and generate a corresponding oscillation frequency to an output unit electrically coupled with the calculation unit.

20. The operation system for a capacitive stylus of claim 19, wherein the switch unit includes a first switch element and a second switch element, the first switch element and the second switch element being individually electrically coupled with the Colpitts circuit;
wherein, when the first switch element is depressed, the oscillation frequency is within a first frequency domain;
wherein, when the second switch element is depressed, the oscillation frequency is within a second frequency domain.
